(19) United States
(12) Patent Application Publication
(10) Pub. No.: US 2023/0111029 A1
(43) Pub. Date: Apr. 13, 2023

(54) FIREWOOD CORD ROOF

(71) Applicant: ERIC GOBEIL, QUEBEC (CA)

(72) Inventor: ERIC GOBEIL, QUEBEC (CA)

(21) Appl. No.: 17/964,137

(22) Filed: Oct. 12, 2022

Related U.S. Application Data
(60) Provisional application No. 63/255,217, filed on Oct. 13, 2021.

(51) Int. Cl. F26B 9/10

(52) U.S. Cl. CPC F26B 9/10; F26B 2210/16

(57) ABSTRACT

A firewood cord roof disposed on the top of a firewood cord to protect it against bad weather, thus, the firewood cords will dry, stay dry, and ready to use at its maximum. The firewood cord roof looks like a gable roof on the top of a house, here it is a gable roof on the top of the cord of firewood. The firewood cord roof is firmly attached to lower logs of the firewood cord so as not to be thrown down by the bad weather. The firewood cord roof comprises a wooden and plastic membrane framework structure disposed above the firewood cord and a roof covering membrane structure fixed on the wooden and plastic membrane framework structure and covering it, as well as the entire top surface of the firewood cord. Both structures capping the firewood cord like a gable roof on top of a house.

### TECHNICAL FIELD

The present invention belongs to the field of the protection of cords of wood against bad weather.

### OBJECTIVES AND ADVANTAGES

There is a need in the market for protectors of firewood cords which are kept outside against bad weather (snow, water or humidity). Thus, the firewood cords will dry, stay dry, and ready to use at its maximum (without any loss of heat, less chances of insects, rotting wood, etc.). The present invention has a resemblance with a gable roof on the top of a house, here it is a gable roof on the top of the cord of firewood. The present invention permits to water and snow to flow away from the firewood like does a gable roof for a house; the walls are better protected when the roof extends far from house walls.

### DESCRIPTION OF THE INVENTION

The firewood cord roof is a structure looking like a gable roof on the top of a house, the structure is placed on the top of the cord and comprises a wooden and plastic membrane framework structure and a roof covering membrane structure recovering the wooden and plastic membrane framework structure.

The wooden and plastic membrane framework structure comprises:
A central/ridge board, placed all along the firewood cord and centered on the top,
some transverse tie-down arms rafters placed at regular intervals on the ridge board; the tie-down arms rafters are transverse rafters planks attached two by two on both sides of the ridge board by the mean of a plastic membrane attached on their upper surfaces. A first rafter at one side of the ridge board and its opposite rafter at the other side of the ridge board, and between them the membrane is passing over the top of the ridge board to hold the two opposite rafters, thus allowing different rafters slopes.
At the junction of two aligned rafters and the ridge board therefore there is the plastic membrane which passes over the ridge board, covers it, and holds both transverse rafters planks so that they do not slide.
At free ends of the tie-down arms rafters the plastic membrane which is longer than the rafters whereon it is fixed is screwed/attached at each side of the ridge hoard on a log at the bottom of the cord to hold the whole invention.

The roof covering membrane structure comprises a covering membrane ended by sides boards which is recovering all the wooden and plastic membrane framework structure like a unique roof sheet recovering all the gable roof.

### INSTALLATION

1. Install the ridge hoard on the top of the firewood cord.

2. Install or lay down the tie-down arms rafters on the ridge board, with a spacing of about 5′-6′, choose a location between logs which allow equal slopes of the rafters of between 10° -40°.

3. Attach firmly the tie-down arms rafters by attaching the extensions of the plastic membranes at the four free ends of the tie-down arms to logs at the bottom of the firewood cord, use screws and washers, make sure each arm has about the same slope.

4. Staple the covering membrane on sides boards at its longitudinal ends, let the membrane extends for ½″ so water will drop easily, staple every 6″ or more depending on local wind.

5. Install the membrane in final position, over the tie-down arms rafters and the ridge board, then screw the sides boards of the membrane to the tie-down arms rafters, use screw and washer for higher tear resistance.

The present invention will be further understood from the following description with reference to the drawings wherein like numbers refer to like parts for easy identification.

### BRIEF DESCRIPTION OF THE DRAWINGS FIGURES

FIG. 1 is a perspective view of the whole invention on the top of a firewood cord.

FIG. 2 is a perspective view of the wooden and plastic membrane framework on the top of a firewood cord.

FIG. 3 is a perspective view of tie-down arms rafters.

FIG. 4 is a perspective view of the roof covering membrane structure.

### DETAILED DESCRIPTION OF THE PREFERRED EMBODIMENT

In the following description and in the accompanying drawings, the numeral numbers refer to identical parts in the various Figures.

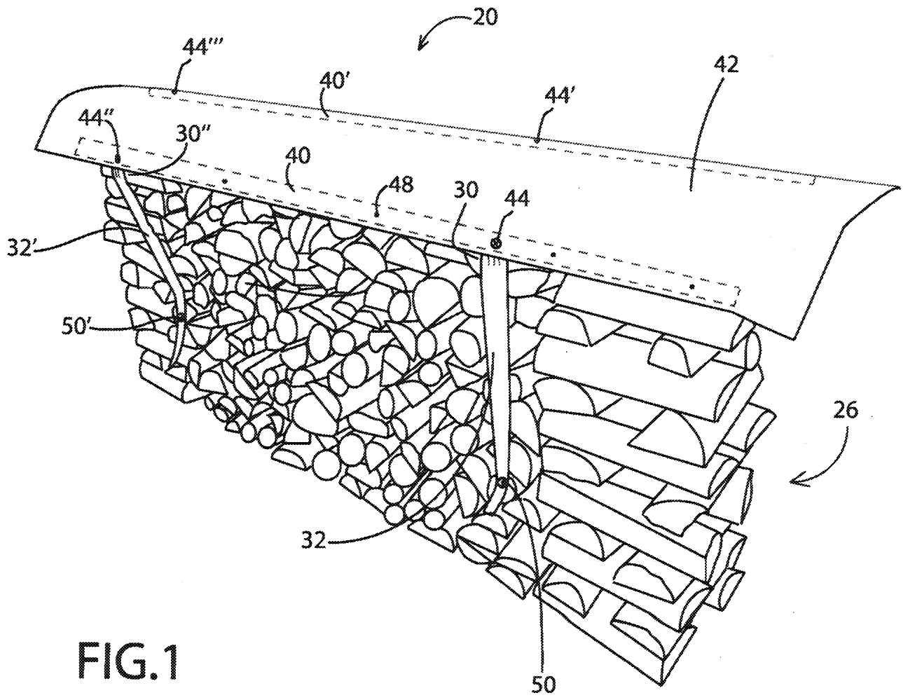

FIG. 1 shows the firewood cord roof 20 installed on the top of a firewood cord 26, like a gable roof on the top of a house, and attached to logs at the bottom of the firewood cord 26 (one sees attachments 50,50′ in one side of the ridge board). The firewood cord roof comprises a covering membrane 42 attached 48 to side boards 40,40′ at its longitudinal ends. The covering membrane is furthermore screwed 44,44′,44″,44′″ to the side boards 40,40′ and also to the plastic membrane 32,32′ and to the rafters in order to be maintained at the top of the firewood cord. One perceives the rafter 30 below the side board 40 and the plastic membrane 32, and the rafter 30″ below the side board 40 and the plastic membrane 32′.

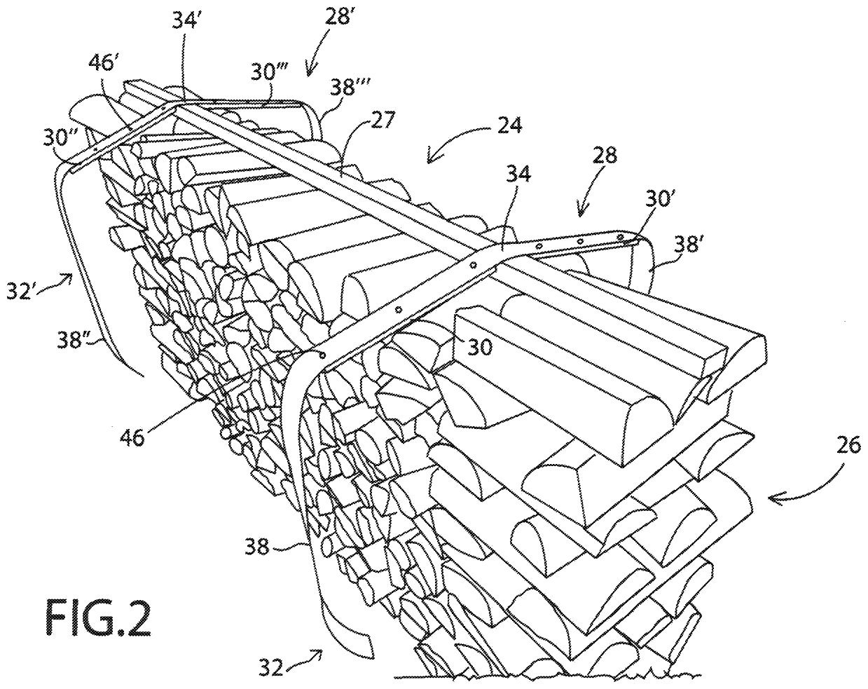

FIG. 2 shows the wooden and plastic membrane framework structure 24 installed on the top of the firewood cord 26 and comprises two tie-down arms rafters 28,28′ and a ridge board 27. The tie-down arm rafters 28 comprises two roof rafters 30 and 30′, one on each side of the ridge board 27. The rafters 30,30′ comprise on its top surfaces the plastic membrane 32 fixed 46 on them and extending 38, 38′ further to the lower logs of the firewood cord at the lower ends of the rafters.

Between both rafters 30,30′ a centering zone 34 of the plastic membrane 32 is covering the ridge board. As well, the tie-down arm rafters 28′ comprises two roof rafters 30″ and 30′″, one on each side of the ridge board. The rafters 30″,30′″ comprise on its top surfaces the plastic membrane 32′ fixed 46′ on them and extending 38″,38′″ further to the lower logs of the firewood cord at the lower ends of the rafters. Between both rafters 30″,30′″ a centering zone 34′ of the plastic membrane 32′ is covering the ridge board.

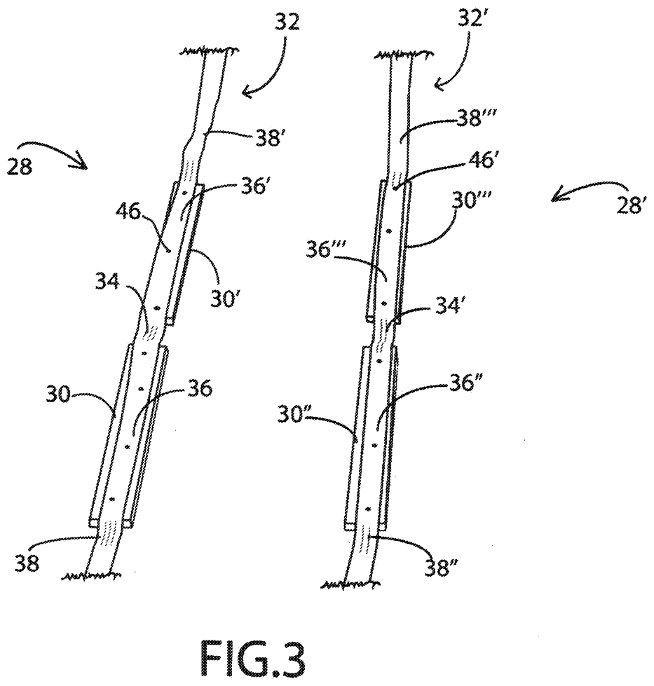

FIG. 3 shows the two tie-down arms rafters 28,28′ on the floor. Each structure comprising two rafters 30,30′ and 30″,30′″ disposed longitudinally with a space between them, and plastic membranes 32,32′. The plastic membranes are fixed on the top surfaces of the rafters, these are the rafter zones 36,36′,36″,36′″ of the membrane; the membrane 32 is fixed 46 above 36,36′ the rafters 30 and 30′, and the membrane 32′ is fixed 46′ above 36″,36′″ the rafters 30″ and 30′″. The centering zones 34,34′ of the membrane 32,32′, between the rafters 30,30′ and 30″,30′″, are intended to be installed on the ridge board. At free ends of each tie-down arms rafters, the extensions 38,38′ of the plastic membrane 32 and the extensions 38″,38′″ of the plastic membrane 32′ (the plastic membranes are longer than the rafters whereon they are fixed) are attached to logs at the bottom of the cord to hold the whole structure.

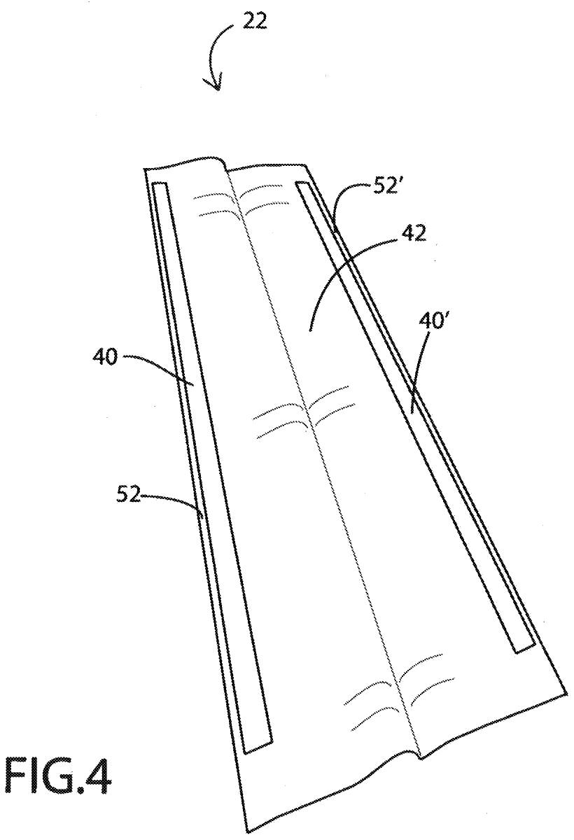

FIG. 4 shows the roof covering membrane 22 comprises a covering membrane 42 attached on its longitudinal ends to side boards 40, 40′. Water dropped zones 52 and 52′ are covering membrane 42 extending about ½″ from side boards to prevent water drop to run or to slide on the membrane inner face then closer to be in contact with logs of the firewood.

### SUMMARY OF THE INVENTION

A firewood cord roof 20 used to protect a firewood cord 26 against bad weather and comprising:
a wooden and plastic membrane framework structure 24 disposed above a firewood cord 26 and extending further than the ends of said firewood cord. The wooden and plastic membrane framework structure 26 is firmly attached 50,50′ to lower logs of the firewood cord 26 so as not to be thrown down by the had weather.
A roof covering membrane structure 22 fixed on the wooden and plastic membrane framework structure 24 and covering it, as well as the entire top surface of the firewood cord 26.

Both structures capping the firewood cord like a gable roof on top of a house.

The wooden and plastic membrane framework structure 24, comprising:
a ridge board 27 placed centered on the top of the firewood cord all along the firewood cord and,
two tie-down arms rafters 28,28′, each of them comprising a rafter 30,30″ in one side of the ridge board and an opposite rafter 30′,30′″ in the other side of the ridge board. Each rafter in one side and its opposite rafter in the other side are attached by a membrane 32,32′ which is fixed 46 on 36,36′,36″,36′″ their upper surfaces and passes, in the middle of them 34,34′, on the ridge hoard. Each membrane 32,32′ extends 38,38′,38″,38′″ at the lower ends of each rafter further to the lower logs of the firewood cord where the extensions are attached 50,50′ to firmly fix the whole wooden and plastic membrane framework structure. Each of the rafter extends away from the firewood cord ends to resemble to the gable roof which extends away from house walls.

Each of the two tie-down arms rafters 28, 28′ is placed between two logs for a best equilibrium, thus allowing an equal slope of each of the rafter of 10°0 to 40°.

The two tie-down arms rafters 28,28′ are spaced 5′ to 6′ apart.

The roof covering membrane structure 22 comprising a covering membrane 42 with at each longitudinal ends a side board 40,40′ fixed 48 on it. The covering membrane extending 52,52′, for example for ½″, from side boards to form water dropped zones which prevent water drop to run or to slide on the membrane inner face then closer to be in contact with the firewood cord. The two side boards are the supports for screwing 44,44′,44″,44′″ the covering membrane to the lower ends of each of the rafters 30,30′,30″,30′″, so the covering membrane will be maintained in place on the top of said firewood cord.

The roof covering membrane structure 22 prevents the creation of small pond which can bring water leaks inside the firewood cord.

The combination of the rafters extending away from the firewood cord sides plus the water dropped zones allow the covering membrane to overhang equally all along from the firewood cord sides, thus diverting water further away from the firewood cord sides.

The covering membrane 42 can be in plastic.

It is to be clearly understood that the instant description with reference to the annexed drawing is made in an indicative manner and that the preferred embodiments described herein are meant in no way to limit further embodiments realizable within the scope of the invention. The matter which is claimed as being inventive and new is limited only by the following claims

### PARTS

20 The firewood cord roof

22 Roof covering membrane structure

24 Wooden and plastic membrane framework structure

26 Firewood cord

27 Ridge board

28,28′ Tie-down arms rafters

30,30′,30″,30′″ Roof rafters

32,32′ Membranes

34,34′ Centering zones of the membranes

36,36′,36″,36′″ Rafter zones of the membranes

38, 38′,38″,38′″ Extensions of the membranes

40,40′ Side boards

42 Covering membrane

44,44′,44″,44′″ Screws between the covering membrane, the side boards, the membranes and the rafters

46 Screws between the membranes and the rafters

48 Screws between the side boards and the covering membrane

50,50′ Attachments of the membrane to the lower logs

52,52′ Water dropped zones

1. A firewood cord roof (20) used to protect a firewood cord (26) against bad weather and comprising:
a wooden and plastic membrane framework structure (24) disposed above said firewood cord (26) and extending further than the ends of said firewood cord (26), said wooden and plastic membrane framework structure (26) is firmly attached (50,50′) to lower logs of said firewood cord (26) so as not to be thrown down by the bad weather,
a roof covering membrane structure (22) fixed on said wooden and plastic membrane framework structure (24) and covering it, as well as the entire top surface of said firewood cord (26),
both structures capping said firewood cord like a gable roof on top of a house.

2. The firewood cord roof of claim I wherein said wooden and plastic membrane framework structure (24), comprising:
a ridge board (27) placed centered on said firewood cord all along said firewood cord and,
two tie-down arms rafters (28,28′). each of them comprising a rafter (30,30″) in one side of said ridge board and an opposite rafter (30′,30′″) in the other side of said ridge board, each of said rafter in one side of said ridge board and its opposite rafter in the other side of said ridge board are attached by a plastic membrane (32,32′) which is fixed (46) on (36,36′,36″,36′″) their upper surfaces and passes in the middle of them (34,34′) on said ridge board, said plastic membrane extends (38,38′,38″,38′″) at the lower ends of each rafters to the lower logs of said firewood cord whereon said extensions are attached (50,50′) to firmly fix said whole wooden and plastic membrane framework structure, each of said two tie-down arms rafters is placed between two logs for a best equilibrium, thus allowing an equal slope of each of said rafter (30,30′30″,30′″) of 10° to 40°, each of said rafter extending away from said firewood cord to resemble to said gable roof extending away from house walls.

3. The firewood cord roof of claim 1 wherein said roof covering membrane structure (22) comprising a covering membrane (42) placed on said wooden and plastic membrane framework structure (24), and with at each longitudinal ends of said covering membrane a side hoard (40,40′) fixed (48) on it, said covering membrane extending (52,52′) from each of said side boards to prevent water drop to slide on an inner face of said covering membrane then closer to logs of said firewood cord.

4. The firewood cord roof of claim 3 wherein said side boards being the supports for screwing (44,44′,44″,44′″) said roof covering membrane (42) to the lower ends of each of said rafters (30,30′,30″,30′″), so said roof covering membrane will be maintained in place on the top of said firewood cord.

5. The firewood cord roof of claim 3 wherein each of said extension of said covering membrane is ½″ long.

6. The firewood cord roof of claim 1 wherein said two tie-down arms rafters (28,28′) are spaced 5′ to 6′ apart.

7. The firewood cord roof of claim 3 wherein said covering membrane (42) is in plastic.
